(19) United States
(12) Patent Application Publication
(10) Pub. No.: US 2026/0110502 A1
(43) Pub. Date: Apr. 23, 2026

(54) HINGED COOLERS

(71) Applicant: SULLAIR, LLC, Michigan City, IN (US)

(72) Inventors: Chris CARPENTER, Michigan City, IN (US); David GUTIERREZ, Michigan City, IN (US); Robert HISER, Michigan City, IN (US)

(21) Appl. No.: 19/117,773

(22) PCT Filed: Feb. 14, 2023
(86) PCT No.: PCT/US2023/013047

§ 371 Date: Apr. 2, 2025

Related U.S. Application Data
(60) Provisional application No. 63/416,893, filed on Oct. 17, 2022.

(51) Int. Cl. F28F 9/00; F28D 21/00

(52) U.S. Cl. CPC F28F 9/001; F28D 2021/004; F28F 2280/105

(57) ABSTRACT

A hinged cooler includes an enclosure in which a cooling fluid flows, a first heat exchanger disposed inside the enclosure for cooling a first fluid by the cooling fluid, a second heat exchanger disposed inside the enclosure for cooling a second fluid by the cooling fluid, and a hinge located between the first heat exchanger and the second heat exchanger. The first heat exchanger rotates 2024/085909 around the hinge, in a first direction, from a first closed position that covers the enclosure to a first open position in which the first heat exchanger moves to an outside of the enclosure. The second heat exchanger rotates around the hinge, in a second direction opposite to the first direction, from a second closed position that covers the enclosure to a second open position in which the second heat exchanger moves to the outside of the enclosure.

### CROSS REFERENCE TO RELATED APPLICATIONS

This patent application is based on and claims the benefit of priority from provisional U.S. patent application Ser. No. 63/416,893, filed on Oct. 17, 2022, the disclosure of which is hereby incorporated by reference herein in its entirety for all purposes.

### BACKGROUND

### Field

The present disclosure is generally related to hinged coolers, and more specifically, to hinged coolers integrated in portable air compressors.

### RELATED ART

In the related art, clean-out panels are provided within a fan shroud to facilitate some access to clean out heat exchangers of a compressor package. Having clean-out panels is better than not having any access to the exchangers at all.

However, challenges occur during cleaning out the debris that falls to the bottom of the fan shroud area and the subsequent wash water from the pressure washing. It is also difficult to maneuver the wash wand within the fan shroud to be effective in cleaning the heat exchangers.

Thus, there is an unmet need for an arrangement for convenient and effective cleaning of heat exchanges of air compressors.

The present invention is directed to a hinged cooler for air compressors to solve the problem of the conventical systems by gaining access to both sides of the heat exchangers for service and cleaning, improving both the quality of the cleaning and the time it takes to complete the cleaning.

### SUMMARY

The subject invention is a hinged cooler for compressors, and for particularly portable compression devices.

The concept is unique in that the air heat exchangers are hinged to allow them to swing out of the envelope of the compressor system to be cleaned. The system generally includes four main entities including an oil cooler, an aftercooler, a hinge, and a framework that bolts them all together and holds the system within a compressor assembly.

Aspects of the present disclosure involve a hinged cooler that includes an enclosure in which a cooling fluid flows, a first heat exchanger disposed inside the enclosure for cooling a first fluid by the cooling fluid, a second heat exchanger disposed inside the enclosure for cooling a second fluid by the cooling fluid, and a hinge located between the first heat exchanger and the second heat exchanger.

The first heat exchanger rotates around the hinge, in a first direction, from a first closed position that covers the enclosure to a first open position in which the first heat exchanger moves to an outside of the enclosure. The second heat exchanger rotates around the hinge, in a second direction opposite to the first direction, from a second closed position that covers the enclosure to a second open position in which the second heat exchanger moves to the outside of the enclosure.

Aspects of the present disclosure further involve a compressor system that includes a compressor, a fan that provides a cooling air, an enclosure in which the cooling air flows, an oil heat exchanger disposed inside the enclosure for cooling an oil of the compressor by the cooling air, an aftercooler heat exchanger disposed inside the enclosure for cooling a compressed air of the compressor by the cooling air, and a hinge located between the oil heat exchanger and the aftercooler heat exchanger.

The oil heat exchanger rotates around the hinge, in a first direction, from a first closed position that covers the enclosure to a first open position in which the oil heat exchanger moves to an outside of the enclosure. The aftercooler heat exchanger rotates around the hinge, in a second direction opposite to the first direction, from a second closed position that covers the enclosure to a second open position in which the aftercooler heat exchanger moves to the outside of the enclosure.

Aspects of the present disclosure further involve a hinged cooling means that includes an enclosure in which a cooling fluid flows, a first heat exchange means disposed inside the enclosure for cooling a first fluid by the cooling fluid, a second heat exchange means disposed inside the enclosure for cooling a second fluid by the cooling fluid, and a hinging means located between the first heat exchange means and the second heat exchange means.

The first heat exchange means rotates around the hinging means, in a first direction, from a first closed position that covers the enclosure to a first open position in which the first heat exchange means moves to an outside of the enclosure. The second heat exchange means rotates around the hinging means, in a second direction opposite to the first direction, from a second closed position that covers the enclosure to a second open position in which the second heat exchange means moves to the outside of the enclosure.

With the exemplary aspects of the present disclosure, a hinged cooler can be provided to solve having cumbersome access to clean the heat exchangers by swinging the exchangers out of the envelope of the machine for an easy access for cleaning and maintenance.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1A illustrates an example hinged cooler for an air compressor in coolers closed position, in accordance with an example implementation.

FIG. 1B illustrates an example hinged cooler for an air compressor in coolers open position, in accordance with an example implementation.

FIG. 2 illustrates an example view of a compressor system with a hinged cooler, in accordance with an example implementation.

FIG. 3 illustrates an example view of a hinged cooler with coolers and a hinge, in accordance with an example implementation.

FIG. 4 illustrates an example of a cross-sectional view of a hinged cooler with a fan of a compressor system, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application. Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

Example implementations described herein involve a hinged cooler for a compressor system that can provide a solution to manage efficient cleaning and repair of aftercooler heat exchanger and oil heat exchanger of the compressor system.

For some applications, the compressed air provided by a compressor needs to be cooled to a desired temperature by an aftercooler before being delivered to an end user.

Additionally, the circulation oil of an air compressor needs to be cooled by an oil heat exchanger before being returned to the compressor in a closed oil cycle.

Both of the aftercooler heat exchanger and the oil heat exchanger can be placed side-by-side in an enclosure to share an air cooling fluid for cooling the compressed air and oil, respectively.

Such a design can be applied in air compressor packages, primarily portable type machines that regularly need cleaning of the heat exchangers (coolers) because they are typically outside in challenging environments with dust and debris.

Other applications would be for any vehicle or portable or stationary equipment that has a cooling system with heat exchangers that would need periodic cleaning such as generators, chillers, air compressors, pumps, compactors, earth moving equipment, loaders, dozers, skid steers, graders, excavators, on-highway trucks, motorized recreational vehicles, commercial vehicles, passenger cars and trucks, etc.

The hinged cooler concept can also be used in a portable electric air compressor. The hinged coolers are a part of the cooling system within the air compressor package.

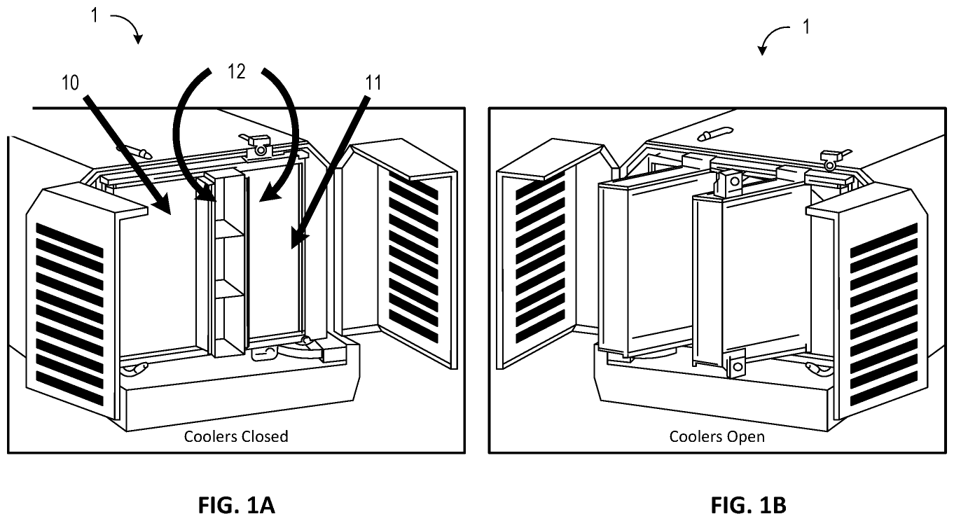

FIG. 1A illustrates an example hinged cooler 1 for an air compressor in coolers closed position. This system shows the oil heat exchanger 10 and aftercooler heat exchanger 11 at the back of the compressor system where doors of the compressor system are open, exposing the hinged coolers with the hinge 12 disposed between the oil heat exchanger 10 and aftercooler heat exchanger 11.

FIG. 1B illustrates an example hinged cooler 1 for the air compressor in coolers open position. This system shows the oil heat exchanger 10 and the aftercooler heat exchanger 11 at the back of the compressor system where doors of the compressor system are open, exposing the hinged coolers with the hinge 12 disposed between the oil heat exchanger 10 and aftercooler heat exchanger 11. The hinged mechanism allows the oil heat exchanger 10 and aftercooler heat exchanger 11 swing out for access to clean them in the cooler open position, and then swing them back closed when finished cleaning to the coolers close position shown in FIG. 1A.

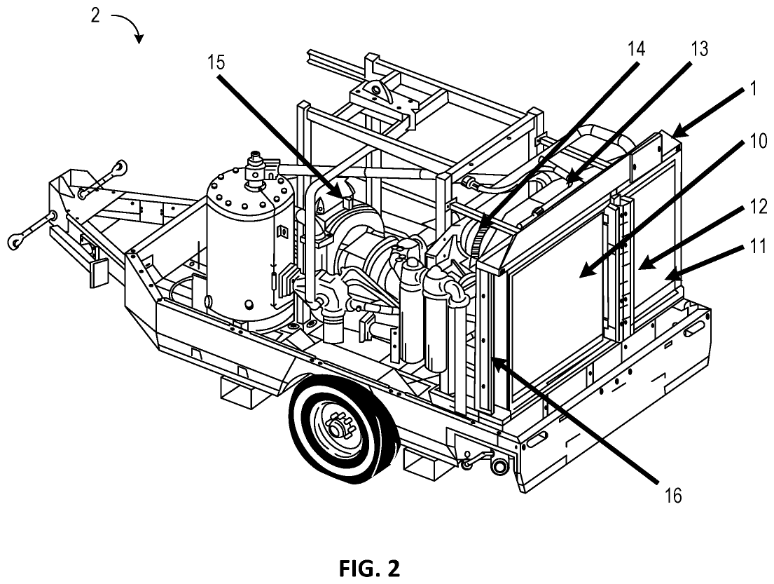

FIG. 2 illustrates an example view of a compressor system 2 with a hinged cooler 1 as shown in FIGS. 1A and 1B incorporated into the compressor system 2, in accordance with an example implementation.

Hinge 12 is provided between the oil heat exchanger 10 and the aftercooler heat exchanger 11 to facilitate rotation of each of the heat exchangers 10 and 11 toward another one of the heat exchangers 10 and 11.

Fan 14 provides cooling air into the enclosure 13 as the cooling fluid for the oil heat exchanger 10 and the aftercooler heat exchanger 11.

Compressed air, provided by compressor 15, passes through the aftercooler heat exchanger 11 for cooling before exiting the compressor system 2 for delivery to an end user.

Oil that exits the compressor 15 flows in a closed cycle that passes through the oil heat exchanger 10 for cooling by the cooling air provided from the fan 14 before returning to the compressor 15.

Frame 16, which is removable, provides support for securing the oil heat exchanger 10 and the aftercooler heat exchanger 11 into the enclosure 13.

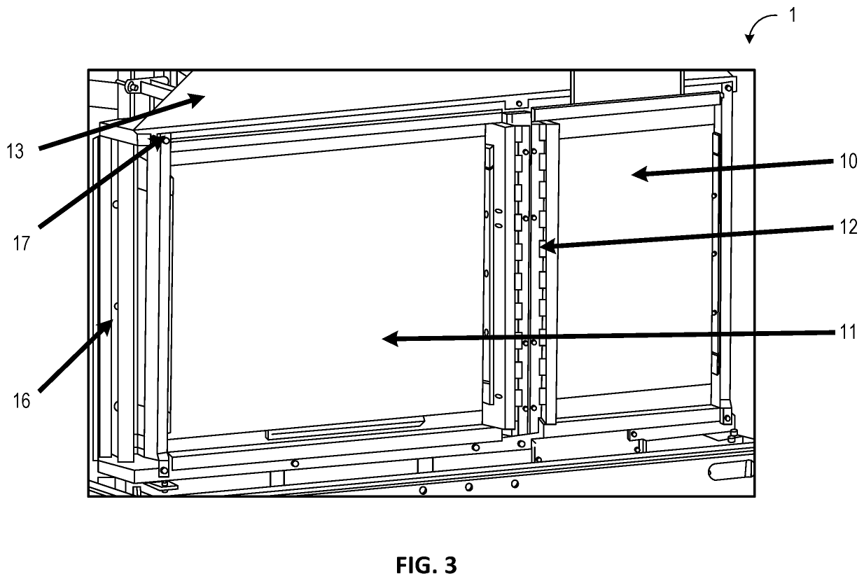

FIG. 3 illustrates an example view of the oil heat exchanger 10 and the aftercooler heat exchanger 11 and a hinge 12 disposed between the heat exchangers 10 and 11, in accordance with an example implementation.

Hinge 12 includes a first hinge attached to the oil heat exchanger 10 that provides rotation for the oil heat exchanger 10 toward the aftercooler heat exchanger 11.

Further, hinge 12 includes a second hinge attached to the aftercooler heat exchanger 11 that provides rotation for the aftercooler heat exchanger 11 toward the oil heat exchanger 10.

Bolts 17 are provided in a vicinity of frame 16 on opposing sides of the oil heat exchanger 10 and the aftercooler heat exchanger 11 to facilitate securing the heat exchangers 10 and 11 to the enclosure 13, and rotation of the heat exchangers 10 and 11 from the enclosure 13, upon removal of the bolts 17.

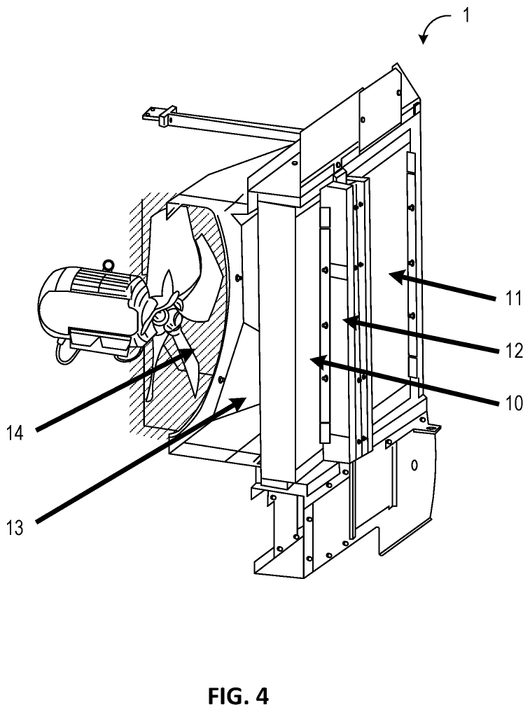

FIG. 4 illustrates an example of a cross-sectional view of the hinged cooler 1 with a fan 14 of a compressor system, in accordance with an example implementation.

The oil heat exchanger 10 and the aftercooler heat exchanger 11 share a same cooling air flow that is provided by the fan 14 for cooling oil and air that internally pass through the oil heat exchanger 10 and the aftercooler heat exchanger 11, respectively.

Fan 14 is located on opposing side of the enclosure 13 with respect to the oil heat exchanger 10 and the aftercooler heat exchanger 11 such that the cooling air flows through the enclosure 13 before entering the oil heat exchanger 10 and the aftercooler heat exchanger 11.

Hinge 12 protrudes from the enclosure 13 to the outside of the enclosure 13 in a width direction of the enclosure 13.

Based on the above-mentioned configurations, an exemplary aspect of the present invention is directed to a hinged cooler 1 as shown in FIGS. 1A, 1B, and 2.

The hinged cooler 1 includes an enclosure 13 in which a cooling fluid flows, a first heat exchanger 10 that is disposed inside the enclosure 13 for cooling a first fluid by the cooling fluid, a second heat exchanger 11 disposed inside the enclosure 13 for cooling a second fluid by the cooling fluid, and a hinge 12 located between the first heat exchanger 10 and the second heat exchanger 11.

As shown in FIG. 1A and 1B, the first heat exchanger 10 rotates around the hinge 12, in a first direction, from a first closed position that covers the enclosure 13 to a first open position in which the first heat exchanger 10 moves to an outside of the enclosure 13.

Further, the second heat exchanger 11 rotates around the hinge 12, in a second direction opposite to the first direction, from a second closed position that covers the enclosure 13 to a second open position in which the second heat exchanger 11 moves to the outside of the enclosure.

As shown in FIG. 2, the hinged cooler 1 further includes a removable frame 16 that is attached to opposing sides of the first heat exchanger 10 and the second heat exchanger 11 with respect to sides of the first heat exchanger 10 and the second heat exchanger 11 that are located adjacent to the hinge 12.

As shown in FIG. 3, the removable frame 16 is attached to the opposing sides of the first heat exchanger 10 and the second heat exchanger 11 by a plurality of bolts 17 that are removable for rotations of the first heat exchanger 10 and the second heat exchanger 11 around the hinge 12.

The hinge 12, as shown in FIG. 3, includes a first hinge attached to a side surface of the first heat exchanger 10, and a second hinge attached to a side surface of the second heat exchanger 11.

The first hinge and the second hinge are located side-by-side between the first heat exchanger 10 and the second heat exchanger 11.

As shown in FIG. 4, the hinged cooler 1 further includes a fan 14 disposed on opposing side of the enclosure 13 from a side of the enclosure 13 in which the first heat exchanger 10 and the second heat exchanger 11 are disposed.

The fan 14 provides the cooling fluid to the enclosure 13 to cool the first fluid running inside the first heat exchanger 10 and the second fluid running inside the second heat exchanger 11.

As shown in FIG. 2, the first fluid may include an oil that passed through a compressor 15, and the second fluid may include an air that is compressed in the compressor 15.

The compressor 15 may include a portable electric compressor.

As shown in FIG. 1B, after rotations of the first heat exchanger 10 and the second heat exchanger 11 around the hinge 13, an inside of the enclosure 13 is exposed to the outside such that an entirety of the first heat exchanger 10 and the second heat exchanger 11 move to the outside of the enclosure 13.

The first heat exchanger 10 rotates forward around the hinge 12, from the first closed position shown in FIG. 1A to the first open position shown in FIG. 1B, toward the second heat exchanger 11.

The first heat exchanger 10 rotates backward around the hinge 12, from the first open position shown in FIG. 1B to the first closed position shown in FIG. 1A, away from the second heat exchanger 11.

The second heat exchanger 11 rotates forward around the hinge 12, from the second closed position shown in FIG. 1A to the second open position shown in FIG. 1B, toward the first heat exchanger 10.

The second heat exchanger 11 rotates backward around the hinge 12, from the second open position shown in FIG. 1B to the second closed position shown in FIG. 1A, away from the first heat exchanger 10.

In the first closed position and the second closed position shown in FIG. 2, outer surfaces of the first heat exchanger 10 and the second heat exchanger 11, which are exposed to the outside of the enclosure 13, are located side-by-side in a length direction of the enclosure 13.

The hinge 12 protrudes from the enclosure 13 to the outside of the enclosure 13 in a width direction of the enclosure 13.

Another exemplary aspect of the present invention is directed to a compressor system 2 shown in FIG. 2.

The compressor system 2 includes a compressor 15, a fan 14 that provides a cooling air, an enclosure 13 in which the cooling air flows, an oil heat exchanger 10 disposed inside the enclosure 13 for cooling an oil of the compressor 15 by the cooling air, an aftercooler heat exchanger 11 disposed inside the enclosure 13 for cooling a compressed air of the compressor 15 by the cooling air, and a hinge 12 located between the oil heat exchanger 10 and the aftercooler heat exchanger 11.

The oil heat exchanger 10 rotates around the hinge 12, in a first direction, from a first closed position that covers the enclosure to a first open position in which the oil heat exchanger 10 moves to an outside of the enclosure 13 as shown in FIGS. 1A and 1B.

The aftercooler heat exchanger 11 rotates around the hinge 12, in a second direction opposite to the first direction, from a second closed position that covers the enclosure shown in FIG. 1A to a second open position in which the aftercooler heat exchanger 11 moves to the outside of the enclosure 13 as shown in FIG. 1B.

As shown in FIG. 3, the compressor system 2 further includes a removable frame 16 that is attached to opposing sides of the oil heat exchanger 10 and the aftercooler heat exchanger 11 with respect to sides of the oil heat exchanger 10 and the aftercooler heat exchanger 11 that are located adjacent to the hinge 12.

The removable frame 16 is attached to the opposing sides of the oil heat exchanger 10 and the aftercooler heat exchanger 11 by a plurality of bolts 17 that are removable for rotations of the oil heat exchanger 10 and the aftercooler heat exchanger 11 around the hinge 12.

The hinge 12, shown in FIG. 3, includes a first hinge attached to a side surface of the oil heat exchanger 10, and a second hinge attached to a side surface of the aftercooler heat exchanger 11.

The first hinge and the second hinge are located side-by-side between the oil heat exchanger 10 and the aftercooler heat exchanger 11.

The compressor 15 shown in FIG. 3 may include a portable electric compressor.

As shown in FIG. 3, after rotations of the oil heat exchanger 10 and the aftercooler heat exchanger 11 around the hinge 12, an inside of the enclosure 13 is exposed to the outside such that an entirety of the oil heat exchanger 10 and the aftercooler heat exchanger 11 move to the outside of the enclosure 13.

As shown in FIGS. 1A and 1B, the oil heat exchanger 10 rotates forward around the hinge 12, from the first closed position to the first open position, toward the aftercooler heat exchanger 11.

The oil heat exchanger 10 rotates backward around the hinge 12, from the first open position to the first closed position, away from the aftercooler heat exchanger 11.

The aftercooler heat exchanger 11 rotates forward around the hinge 12, from the second closed position to the second open position, toward the oil heat exchanger 10.

The aftercooler heat exchanger 11 rotates backward around the hinge 12, from the second open position to the second closed position, away from the oil heat exchanger 10.

As shown in FIG. 2, in the first closed position and the second closed position, outer surfaces of the oil heat exchanger 10 and the aftercooler heat exchanger 11, which are exposed to the outside of the enclosure 13, are located side-by-side in a length direction of the enclosure 13.

The hinge 12 protrudes from the enclosure 13 to the outside of the enclosure 13 in a width direction of the enclosure 13.

Based on the above-mentioned exemplary embodiments, by making the heat exchangers hinged and allowing space for them to swing out of the envelope of the machine package, it allows ample access to clean the exchangers such that the cleaning spray from pressure washing and debris does not drop down into the machine frame.

Further, the cleaning spray and debris falls outside of the machine package and can easily be contained and disposed of properly. After cleaning, the heat exchangers can easily be swung back into their working position. This improves the quality of the cleaning since there is ample access to both sides of the heat exchanger during cleaning. It also improves the overall time required to complete the cleaning since the exchangers can easily be swung from working position to cleaning position and back to working position.

Moreover, the centrally located hinge is noteworthy. With the coolers attached to the hinges, the hinge and hinge bolted joint takes a lot of force when it is open. This force is transmitted through the bolted structure. The design is such that the centrally located hinge framework is substantially rigid and was considered a novel solution above other hinge locations such as hinges located at the extreme sides so as to make the coolers swing towards the outer sides. In that case substantial structure would need placed at the sides, doubling the structure, increasing complexity, weight and cost.

Another unique aspect of the present invention is that the compressor package is an electric portable compressor, as opposed to a stationary electric compressor or a portable diesel compressor. Being a portable electric compressor, the cooling system is simplified compared to a portable diesel compressor in that there is no engine radiator nor a charge air cooler, just the necessary compressor oil cooler and aftercooler.

Swinging out two coolers is much less complex than swinging out the additional coolers that would be required for a diesel powered machine. As for a stationary electric compressor, they are commonly installed inside a building with a generally cleaner atmosphere than for a portable compressor which is typically placed in dirtier environments such as outside petrochemical plants or construction sites.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

The foregoing detailed description has set forth various example implementations of the devices and/or processes via the use of diagrams, schematics, and examples. Insofar as such diagrams, schematics, and examples contain one or more functions and/or operations, each function and/or operation within such diagrams, or examples can be implemented, individually and/or collectively, by a wide range of structures. While certain example implementations have been described, these implementations have been presented by way of example only and are not intended to limit the scope of the protection. Indeed, the novel methods and apparatuses described herein may be embodied in a variety of other forms. Furthermore, various omissions, substitutions and changes in the form of the devices and systems described herein may be made without departing from the spirit of the protection. The accompanying claims and their equivalents are intended to cover such forms or modifications as would fall within the scope and spirit of the protection.

What is claimed is:

1. A hinged cooler, comprising:
an enclosure in which a cooling fluid flows;
a first heat exchanger disposed inside the enclosure for cooling a first fluid by the cooling fluid;
a second heat exchanger disposed inside the enclosure for cooling a second fluid by the cooling fluid; and
a hinge located between the first heat exchanger and the second heat exchanger,
wherein the first heat exchanger rotates around the hinge, in a first direction, from a first closed position that covers the enclosure to a first open position in which the first heat exchanger moves to an outside of the enclosure, and
wherein the second heat exchanger rotates around the hinge, in a second direction opposite to the first direction, from a second closed position that covers the enclosure to a second open position in which the second heat exchanger moves to the outside of the enclosure.

2. The hinged cooler according to claim 1, further comprising:
a removable frame that is attached to opposing sides of the first heat exchanger and the second heat exchanger with respect to sides of the first heat exchanger and the second heat exchanger that are located adjacent to the hinge.

3. The hinged cooler according to claim 2, wherein the removable frame is attached to the opposing sides of the first heat exchanger and the second heat exchanger by a plurality of bolts that are removable for rotations of the first heat exchanger and the second heat exchanger around the hinge.

4. The hinged cooler according to claim 1, wherein the hinge comprises:
a first hinge attached to a side surface of the first heat exchanger; and
a second hinge attached to a side surface of the second heat exchanger, and
wherein the first hinge and the second hinge are located side-by-side between the first heat exchanger and the second heat exchanger.

5. The hinged cooler according to claim 1, further comprising:
a fan disposed on opposing side of the enclosure from a side of the enclosure in which the first heat exchanger and the second heat exchanger are disposed,
wherein the fan provides the cooling fluid to the enclosure to cool the first fluid running inside the first heat exchanger and the second fluid running inside the second heat exchanger.

6. The hinged cooler according to claim 5, wherein the first fluid comprises an oil that passed through a compressor, and the second fluid comprises an air that is compressed in the compressor.

7. The hinged cooler according to claim 6, wherein the compressor comprises a portable electric compressor.

8. The hinged cooler according to claim 1, wherein, after rotations of the first heat exchanger and the second heat exchanger around the hinge, an inside of the enclosure is exposed to the outside such that an entirety of the first heat exchanger and the second heat exchanger move to the outside of the enclosure.

9. The hinged cooler according to claim 1, wherein the first heat exchanger rotates forward around the hinge, from the first closed position to the first open position, toward the second heat exchanger, and
wherein the first heat exchanger rotates backward around the hinge, from the first open position to the first closed position, away from the second heat exchanger.

10. The hinged cooler according to claim 9, wherein the second heat exchanger rotates forward around the hinge, from the second closed position to the second open position, toward the first heat exchanger, and
wherein the second heat exchanger rotates backward around the hinge, from the second open position to the second closed position, away from the first heat exchanger.

11. The hinged cooler according to claim 1, wherein, in the first closed position and the second closed position, outer surfaces of the first heat exchanger and the second heat exchanger, which are exposed to the outside of the enclosure, are located side-by-side in a length direction of the enclosure, and
wherein the hinge protrudes from the enclosure to the outside of the enclosure in a width direction of the enclosure.

12. A compressor system, comprising:
a compressor;
a fan that provides a cooling air;
an enclosure in which the cooling air flows;
an oil heat exchanger disposed inside the enclosure for cooling an oil of the compressor by the cooling air;
an aftercooler heat exchanger disposed inside the enclosure for cooling a compressed air of the compressor by the cooling air; and
a hinge located between the oil heat exchanger and the aftercooler heat exchanger,
wherein the oil heat exchanger rotates around the hinge, in a first direction, from a first closed position that covers the enclosure to a first open position in which the oil heat exchanger moves to an outside of the enclosure, and wherein the aftercooler heat exchanger rotates around the hinge, in a second direction opposite to the first direction, from a second closed position that covers the enclosure to a second open position in which the aftercooler heat exchanger moves to the outside of the enclosure.

13. The compressor system according to claim 12, further comprising:
a removable frame that is attached to opposing sides of the oil heat exchanger and the aftercooler heat exchanger with respect to sides of the oil heat exchanger and the aftercooler heat exchanger that are located adjacent to the hinge.

14. The compressor system according to claim 13, wherein the removable frame is attached to the opposing sides of the oil heat exchanger and the aftercooler heat exchanger by a plurality of bolts that are removable for rotations of the oil heat exchanger and the aftercooler heat exchanger around the hinge.

15. The compressor system according to claim 12, wherein the hinge comprises:
a first hinge attached to a side surface of the oil heat exchanger; and
a second hinge attached to a side surface of the aftercooler heat exchanger, and
wherein the first hinge and the second hinge are located side-by-side between the oil heat exchanger and the aftercooler heat exchanger.

16. The compressor system according to claim 12, wherein the compressor comprises a portable electric compressor.

17. The compressor system according to claim 12, wherein, after rotations of the oil heat exchanger and the aftercooler heat exchanger around the hinge, an inside of the enclosure is exposed to the outside such that an entirety of the oil heat exchanger and the aftercooler heat exchanger move to the outside of the enclosure.

18. The compressor system according to claim 12, wherein the oil heat exchanger rotates forward around the hinge, from the first closed position to the first open position, toward the aftercooler heat exchanger, and
wherein the oil heat exchanger rotates backward around the hinge, from the first open position to the first closed position, away from the aftercooler heat exchanger.

19. The compressor system according to claim 18, wherein the aftercooler heat exchanger rotates forward around the hinge, from the second closed position to the second open position, toward the oil heat exchanger, and
wherein the aftercooler heat exchanger rotates backward around the hinge, from the second open position to the second closed position, away from the oil heat exchanger.

20. The compressor system according to claim 12, wherein, in the first closed position and the second closed position, outer surfaces of the oil heat exchanger and the aftercooler heat exchanger, which are exposed to the outside of the enclosure, are located side-by-side in a length direction of the enclosure, and
wherein the hinge protrudes from the enclosure to the outside of the enclosure in a width direction of the enclosure.
